(19) United States
(12) Patent Application Publication
(10) Pub. No.: US 2013/0045632 A1
(43) Pub. Date: Feb. 21, 2013

(54) User-Friendly No-Metal Shell USB male Connector

(71) Applicant: Joseph Lai, San Pedro, CA (US)

(72) Inventor: Joseph Lai, San Pedro, CA (US)

(21) Appl. No.: 13/212,204

(22) Filed: Aug. 18, 2011

(51) Int. Cl. H01R 24/28; H01R 43/20

(52) U.S. Cl. 439/626; 29/876

(57) ABSTRACT

This present invention is for a new user-friendly, thin, slim, no-metal shell USB male connector that is able to be inserted into a standard USB female receptacle in either orientation.

### CROSS-REFERENCES

This application incorporates by reference the U.S. Pat. No. 7,717,717 in its entirety. Joseph Lai is the sole inventor of the U.S. Pat. No. 7,717,717 and the invention disclosed in this application.

### FIELD OF THE INVENTION

This present invention is generally related to USB (Universal Serial Bus) connectors, and specifically to providing a more user-friendly connections for new no metal frame type of USB male connectors.

### BACKGROUND OF THE INVENTION

The Universal Serial Bus (USB) has become the standard peripheral interface for many electronic devices, including all modern day computers running Window, Mac, or Linux operating systems. Cost and size for USB devices are getting more competitive, and the thin, slim, no-metal shell USB male connectors are getting more popular.

These no-metal shell USB male connector based products are very useful for USB dongle type of products. For example, devices such as USB Flash Drives, USB memory card readers, USB software protection dongle keys, and wifi/Bluetooth dongles. These no-metal shell USB male connectors are not suitable for USB cable type of products as there is no shielding and not much holding force to hold them.

These no-metal shell USB male connectors can be inserted into a USB socket in either orientation, unlike its predecessor conventional USB male connector which can go into the USB female counter part in only one orientation. However, the no-metal shell USB male connector will only work in only one of the two ways it can be plugged in.

In order to allow the no-metal shell USB male connector to work regardless of which way it is plugged in, a configuration similar to that disclosed by Joe Lai in his U.S. Pat. No. 7,717,717 can be used so that no-metal-shell USB male connectors can be used regardless of which way it is plugged in. However, the no-metal shell USB male connector may short out to the metal housing of the USB type A female receptacle. This might damage the host device and/or the USB peripheral.

### SUMMARY OF THE INVENTION

An embodiment of the invention may comprise a USB male connector that includes a connector piece with a plurality of conductive contacts on a first side of the connector piece and on a second side of the connector piece, where for each of the plurality of conductive contacts on the first side there is a corresponding conductive contact on the second side. There may be a first diode coupled to a first conductive contact, and a second diode coupled to a second conductive contact. The first conductive contact may be on the first side of the connector piece and the second conductive contact may be on the second side of the connector piece, and the second conductive contact may be a corresponding conductive contact of the first conductive contact.

Another embodiment of the invention may comprise a method for making a USB male connector that includes coupling a first diode to a first conductive contact on a first side of a connector piece and coupling a second diode to a second conductive contact on a second side of the connector piece. The connector piece may comprise a plurality of conductive contacts on the first side of the connector piece and a plurality of conductive contacts on the second side of the connector piece, where each of the plurality of conductive contacts on the first side may have a corresponding conductive contact on the second side. The second conductive contact may be a corresponding conductive contact to the first conductive contact.

### BRIEF DESCRIPTION OF THE DRAWINGS

FIG. 1A, 1B, and 1C. (Prior Art) Views of conventional thin, slim, no-metal shell USB male connector for peripheral or dongle devices.

FIG. 2A, 2B, and 2C. New design of thin, slim, no-metal shell, user-friendly USB male connector.

FIG. 3A and 3B. USB female receptacle for host devices with metal holding tabs on the metal shell.

FIG. 4A, 4B and 4C. New design of thin, slim, no-metal shell, user-friendly USB male connector schematics diagram with protective diodes.

### DETAILED DESCRIPTION

One version of the no-metal shell USB male connectors consists of a printed circuit board with four contacts. These four contacts provide power (+5V, ground) and data signals (D+ and D−).

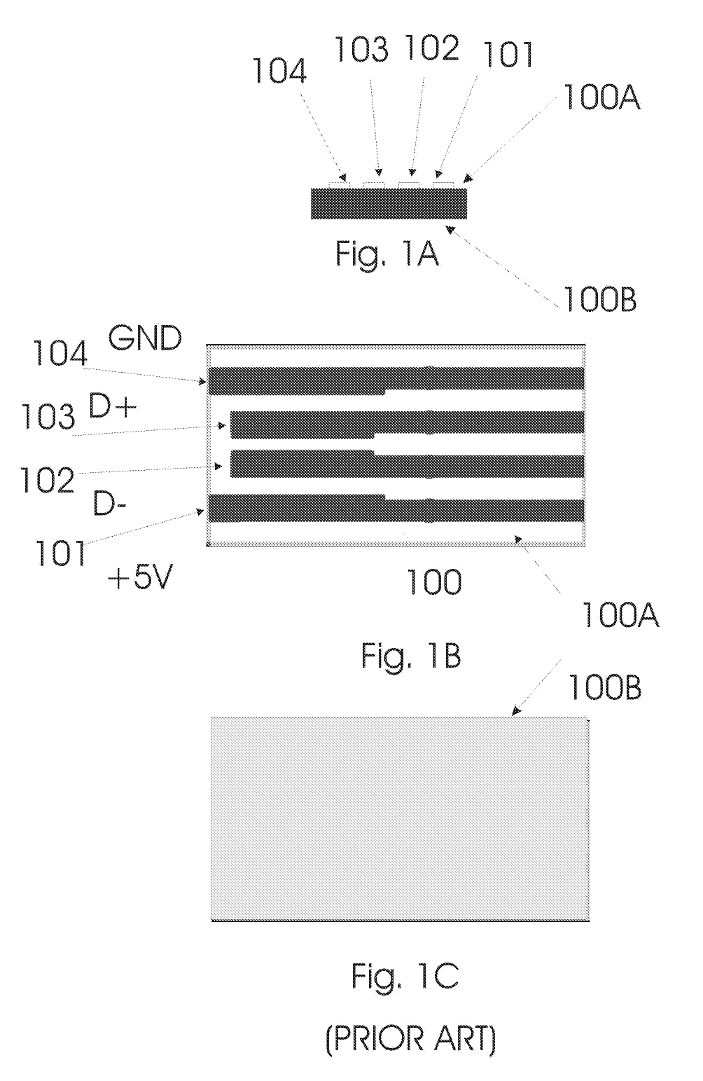

FIG. 1A shows an end view of the prior art no-metal shell USB male connector 100. In FIG. 1B, a top side 100A of the no-metal shell USB male connector 100 shows a power contact +5V 101, a ground contact GND 104, a data contact D+ 103, and a data contact D− 102, while in FIG. 1C, a bottom side 100B of the no-metal shell USB male connector 100 does not have any electrical contacts.

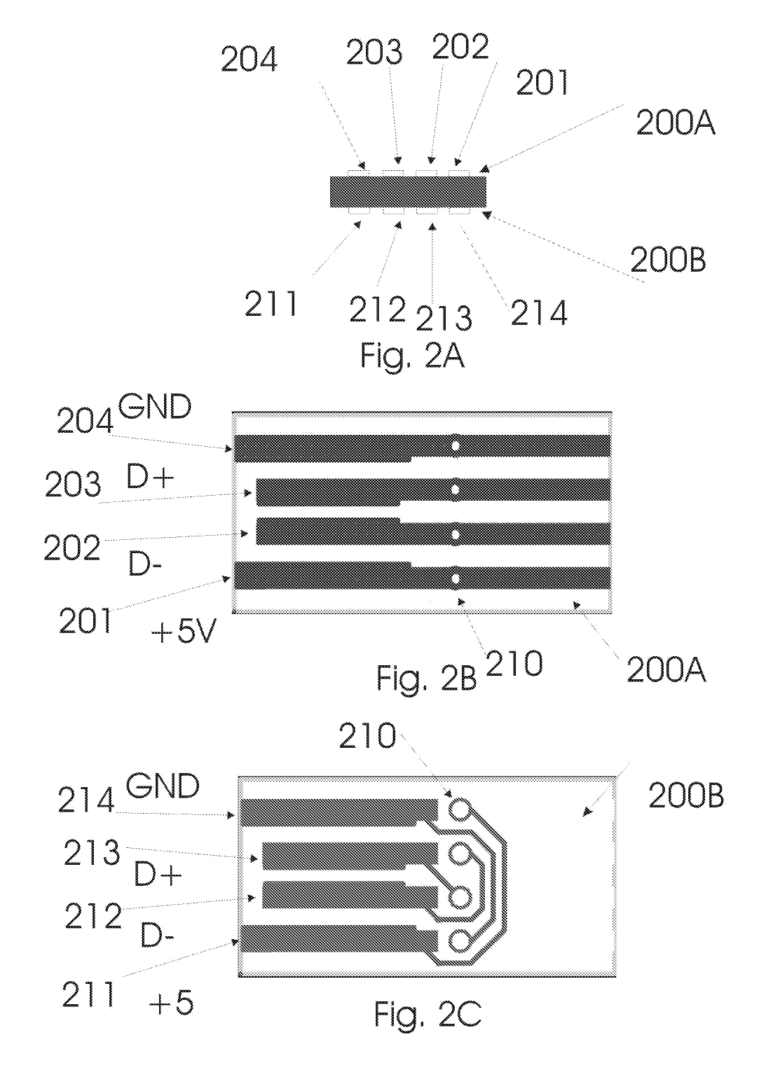

FIG. 2A shows an end view of a user-friendly no-metal shell USB male connector 200 in accordance with an embodiment of the invention. As can be seen, there is shown a top side 200A with a power contact +5V 201, a ground contact GND 204, a data contact D+ 203, and a data contact D− 202. There is also shown a bottom side 200B that has corresponding contacts +5V 211, a GND 214, D+ 213, and D− 212. The corresponding contacts 201 and 211 are electrically shorted to each other, as are each set of the corresponding contacts 202 and 212, 203 and 213, and 204 and 214.

FIG. 2B shows a top side 200A of the user-friendly no-metal shell USB male connector 200. As can be seen, there is a through via 210 so that each of the contacts 201, 201, 203, and 204 can be electrically connected to its corresponding contact 211, 212, 213, or 214.

FIG. 2C shows a bottom side 200B of the user-friendly no-metal shell USB male connector 200. As can be seen, each of the through vias 210 are electrically connected to a corresponding contact 211, 212, 213, or 214. In this way, each contact 211, 212, 213, or 214 on the bottom side 200B can be connected to its corresponding contact 201, 201, 203, or 204 on the top side 200A.

Accordingly, it can be seen that the +5V, GND, +D, and −D contacts of the user-friendly no-metal shell USB male connector 200 will make appropriate contact with corresponding +5V, GND, +D, and −D contacts of the standard USB type A female receptacle regardless of the orientation when inserted into a standard USB type A female receptacle.

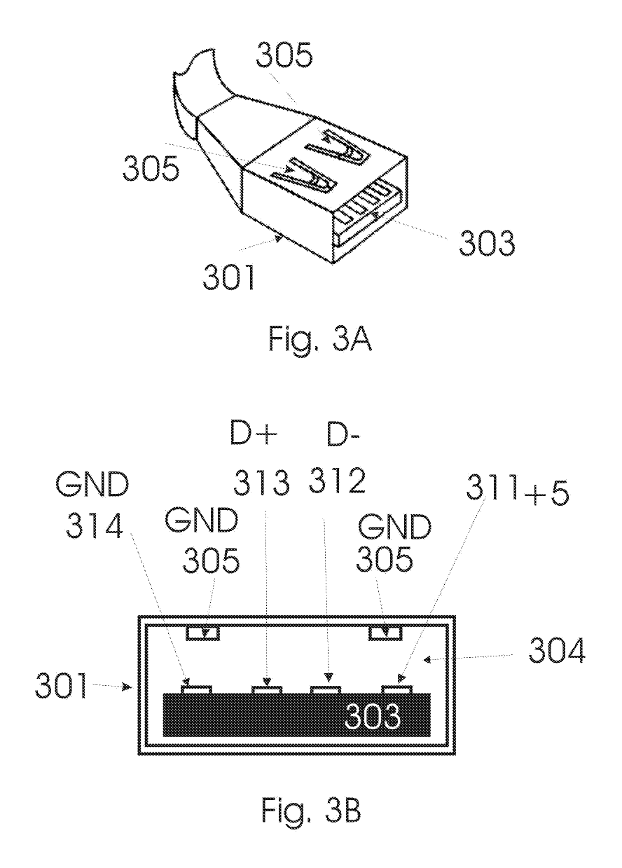

FIG. 3A shows a USB female receptacle 300 for host devices with metal holding tabs on the metal shell. Referring to FIG. 3B, there is shown a metal shell 301, a substrate 303 that provides electrical contacts, and metal tabs 305. The metal tabs 305 act to keep the no-metal shell USB male connector 100 or 200 in place so that a good electrical contact may be made between the no-metal shell USB male connector 100 or 200 and the standard USB type A female receptacle 300. The metal tabs 305 may also be connected to ground of the host device to which it is connected.

FIG. 3B shows an end view of the standard USB type A female receptacle 300. In addition to the metal shell 301, the substrate 303, and the metal tabs 305, there is also shown a power contact +5V 311, a ground contact GND 314, a data contact D+ 313, and a data contact D− 312. Accordingly, when the user-friendly no-metal shell USB male connector 200 is plugged in to the standard USB type A female receptacle 300, there will be an electrical connection between each of the contacts 311, 312, 313, and 314 and a corresponding power or data contact of the user-friendly no-metal shell USB male connector 200 regardless of the orientation in which the user-friendly no-metal shell USB male connector 200 is plugged in.

However, when the user-friendly no-metal shell USB male connector 200 is plugged in, the metal tabs 305 of the standard USB type A female receptacle 300 may short one or more of the contacts on the user-friendly no-metal shell USB male connector 200 to ground. For example, if the contacts 201-204 of the user-friendly no-metal shell USB male connector 200 are touching the corresponding contacts 311-314 of the standard USB type A female receptacle 300, the metal tabs 305 may touch one or more of the exposed contacts 211-214 of the user-friendly no-metal shell USB male connector 200. Accordingly, a safeguard may be needed to prevent shorting of at least the +5V power signal to GND.

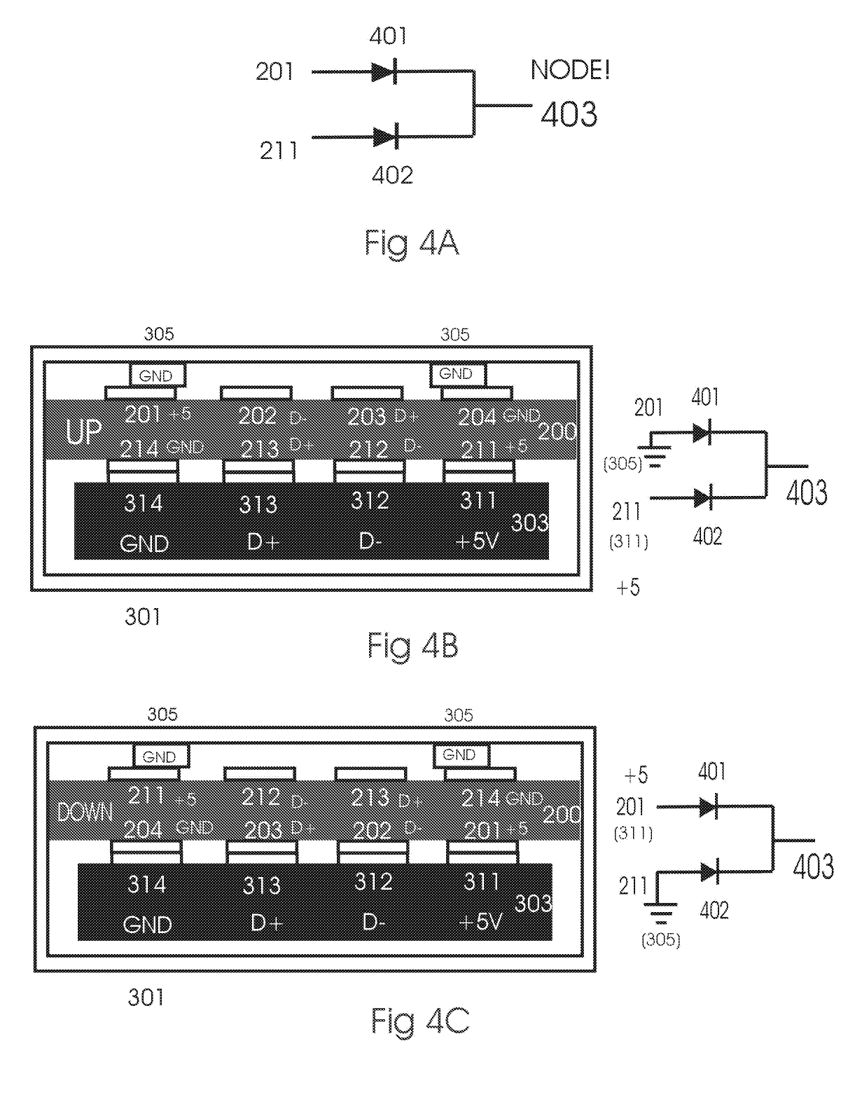

FIG. 4 illustrates two diodes 401 and 402 used to prevent electrical shorting of +5V to ground via the metal tabs 305. Anodes of the diodes 401 and 402 are connected to the power contacts 201 and 211 of the user-friendly no-metal shell USB male connector 200, respectively. The cathodes of the diodes 401 and 402 are connected to each other at node NODE1, which is connected to +5V line of the USB cable to which the user-friendly no-metal shell USB male connector 200 is connected.

As illustrated, when the user-friendly no-metal shell USB male connector 200 is inserted in to the standard USB type A female receptacle 300, the +5V power may be provided to node NODE1 via the diode 402. As can be seen, there may be a short between the +5V contact 201 and the metal tab 305 that is at ground potential. However, because the diode 200 is reverse biased, the node NODE1 will not be shorted to GND. Similarly, when the user-friendly no-metal shell USB male connector 200 is inserted so that the +5V power is received via the diode 401, diode 402 will prevent the node NODE1 from being shorted to GND.

Various embodiments of the invention may use devices such as diodes or diode-configured transistors as diodes 401 and 402. While various types of diodes may be used, diodes that have low forward voltage drop, such as schottky diodes, may be preferred. This is to reduce the amount of voltage drop at the node NODE 1 with respect to the +5V power provided via the contacts 201 and 211. However, the specific types of diodes used are design dependent. Additionally, while the node NODE1 was described as being connected to +5V line of a USB cable, the invention need not be so limited. For example, the node NODE1 may be connected to a circuit trace if the node NODE1 is part of a device such as, for example, a FLASH memory that plugs directly in to the standard USB type A female receptacle 300 of a host device.

There is no need to protect the ground contacts 204 and 214 of the user-friendly no-metal shell USB male connector 200. Additionally, while there may not generally be a need to worry about protecting the data signals at the D+ and D− contacts 203/213 and 202/212, various embodiments of the invention may also provide similar protection for the D+/D− signals. Protection for the data signals may involve more than a simple diode or diode like device. For example, a pull-up or pull-down network may be used to make sure that signal lines are not floating.

I claim:

1. A USB male connector comprising:
a connector piece with a plurality of conductive contacts on a first side of the connector piece and on a second side of the connector piece, wherein for each of the plurality of conductive contacts on the first side there is a corresponding conductive contact on the second side;
a first diode coupled to a first conductive contact; and
a second diode coupled to a second conductive contact,
wherein the first conductive contact is on the first side of the connector piece and the second conductive contact is on the second side of the connector piece, and the second conductive contact corresponds to the first conductive contact.

2. The USB male connector in claim 1, wherein an anode of the first diode is coupled to the conductive contact on the first side, and an anode of the second diode is coupled to the conductive contact on the second side.

3. The USB male connector in claim 1, wherein a cathode of the first diode is coupled to a cathode of the second diode.

4. The USB male connector in claim 3, wherein there is at least one of a pull-up resistor and a pull-down resistor coupled to the cathode of the first diode.

5. The USB male connector in claim 1, wherein the first diode comprises a diode configured transistor.

6. The USB male connector in claim 1, wherein the second diode comprises a diode configured transistor.

7. A method for making a USB male connector comprising:
coupling a first diode to a first conductive contact on a first side of a connector piece; and
coupling a second diode to a second conductive contact on a second side of the connector piece, wherein the connector piece comprises a plurality of conductive contacts on the first side of the connector piece and a plurality of conductive contacts on the second side of the connector piece, each of the plurality of conductive contacts on the first side has a corresponding conductive contact on the second side, and the first conductive contact corresponds to the second conductive contact.

8. The method in claim 7, wherein an anode of the first diode is coupled to the first conductive contact, and an anode of the second diode is coupled to the second conductive contact.

9. The method in claim 7, wherein a cathode of the first diode is coupled to a cathode of the second diode.

10. The method in claim 9, wherein there is at least one of a pull-up resistor and a pull-down resistor coupled the cathode of the first diode.

11. The method in claim 7, wherein the first diode comprises a diode configured transistor.

12. The method in claim 7, wherein the second diode comprises a diode configured transistor.
